(19) United States
(12) Patent Application Publication
(10) Pub. No.: US 2005/0031766 A1
(43) Pub. Date: Feb. 10, 2005

(54) Miso with good flavor containing high amount of isoflavone compounds

(75) Inventors: Noriyoshi Ichijo, Nagano (JP); Takehiro Nishida, Nagano (JP); Masayuki Arii, Chiba (JP); Akio Obata, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: MARUKOME CO., LTD., Nagano-shi (JP); Kikkoman Corporation, Noda-shi (JP)

(21) Appl. No.: 10/873,236

(22) Filed: Jun. 23, 2004

(30) Foreign Application Priority Data
Jun. 24, 2003 (JP) 2003-179537

(51) Int. Cl. A21D 2/00

(52) U.S. Cl. 426/622

(57) ABSTRACT

The purpose of the present invention is to obtain miso with good flavor containing large quantities of isoflavone compounds, which has decreased bitter taste derived from the isoflavone. The present invention relates to miso with good flavor containing large quantities of isoflavone compounds, which is produced by adding 0.1% to 5.0% (W/W) isoflavone compounds (e.g., genistin, daidzin, and glycitin, and aglycons of these compounds including genistein, daidzein, glycitein, and the like) and dried and fermented fish such as dried bonito or boiled-dried fish or a treated product thereof (e.g., a hot water extract of dried and fermented fish or an alcohol extract of dried and fermented fish) to miso, and relates to a method for producing the same.

### FIELD OF THE INVENTION

The present invention relates to miso containing large quantities of isoflavone compounds, which has decreased bitter taste derived from isoflavone compounds, by which a prophylactic or therapeutic effect against osteoporosis can be expected, and which has good flavor. The present invention further relates to a method for producing such miso.

### BACKGROUND OF THE INVENTION

Isoflavone compounds (in particular, isoflavone aglycons) are known to have excellent pharmacological effects of preventing osteoporosis, and the utility thereof is attracting attention [for example, see JP Patent Publication (Kokai) No. 60-48924 A (1985) (page 2, Lines 6-11 in the right top column), JP Patent Publication (Kokai) No. 4-356479 A (1992) (page 2, claim 2 in Claims), JP Patent Publication (Kokai) No. 8-214787 A (1996) (page 3, paragraph number 0012), JP Patent Publication (Kokai) No. 10-114653 A (1998) (page 2, Claims), JP Patent Publication (Kokai) No. 11-243928 A (1999) (page 3, paragraph number 0011), JP Patent Publication (Kokai) No. 2000-139411 A (page 2, paragraph numbers 0002 and 0005), JP Patent Publication (Kokai) No. 2000-191526 A (page 2, claim 1 in Claims), JP Patent Publication (Kokai) No. 2001-95517 A (page 2, paragraph number 0002)].

One of the applicants has previously filed an application for a patent relating to miso containing large quantities of isoflavone compounds, which is produced by adding isoflavone compounds to miso [see JP Patent Publication (Kokai) No. 9-187244 A (1997) (see page 2, claim 1 in Claims)].

However, isoflavone compounds (genistin, daidzin, and glycitin, and aglycons of these compounds including genistein, daidzein, and glycitein) are known to affect taste quality, even in concentrations as extremely low as approximately 10⁻¹ to approximately 10⁻³ mM. For example, according to Soybean Science (Daizu no kagaku, edited by Fumio Yamauchi, Asakura Publishing Company, Ltd., Jun. 20, 1993, pp. 66 to 69), the following has been reported in terms of the relationship between the threshold of each isoflavone compound and taste quality: genistin has weak astringent taste and bitter taste at approximately 10⁻¹ mM; daidzin has astringent taste and weak bitter taste at approximately 10⁻² mM; genistein has astringent taste and subtle bitter taste at approximately 10⁻² mM; and daidzein has astringent taste at approximately 10⁻³ mM (astringent taste means DMF (dry mouth feel) such as bitter taste, astringency, irritated taste, harsh taste, gritty taste, and the like).

A conventionally known method for decreasing bitter taste involves adding organic acids (for example, citric acid, malic acid, ascorbic acid, tartaric acid, and gluconic acid) to isoflavone compounds [for example, see JP Patent Publication (Kokai) No. 2001-95517 A (page 2, claim 1 in Claims).

However, when this method is applied to miso, organic acids must be added at high concentrations. As a result, the effect of reducing bitter taste can be obtained, however, a problem that sourness is newly attached to the miso occurs.

### SUMMARY OF THE INVENTION

The purpose of the present invention is to obtain miso containing large quantities of isoflavone compounds, which has decreased bitter taste derived from the isoflavone compounds, by which a prophylactic or therapeutic effect against osteoporosis can be expected, and which has good flavor.

As a result of intensive studies to achieve the above objectives, we have discovered that upon the production of miso containing large quantities of isoflavone compounds, addition of dried and fermented fish or a treated product thereof results in decreased bitter taste of the isoflavone compounds, and have completed the present invention based on this knowledge.

Specifically, the present invention encompasses the following inventions.

(1) Miso with good flavor containing large quantities of isoflavone compounds, which is produced by adding 0.1-5.0% (W/W) isoflavone compounds and dried and fermented fish or a treated product thereof to miso.

(2) The miso of (1), wherein the dried and fermented fish is finely pulverized.

(3) The miso of (1), wherein the treated product of the dried and fermented fish is a hot water extract or an alcohol extract of the dried and fermented fish.

(4) The miso of any one of (1) to (3), which is produced by adding 0.5 to 50 parts by weight of the dried and fermented fish or the treated product thereof per part by weight of the isoflavone compounds.

(5) A method for producing miso with good flavor containing large quantities of isoflavone compounds, comprising a step of obtaining steamed-boiled soybeans, a step of obtaining koji, a mixing step, a fermentation and ripening step, a pulverization step, and a sterilization step, wherein:

before, during, or after the pulverization step, 0.1% to 5.0% (W/W) isoflavone compounds and 0.5 to 50 parts by weight of dried and fermented fish or a treated product thereof per part by weight of the isoflavone compounds are added to the raw materials for miso.

The present invention is explained in detail as follows. This application claims a priority of Japanese patent application No. 2003-179537 filed on Jun. 24, 2003, and encompasses the content described in the specification of this patent application.

An example of miso to be used in the present invention is any miso that is produced according to a general method for producing miso or a commercial product thereof.

Specifically, miso is produced through: a step (hereinafter referred to as “the step of obtaining steamed-boiled soybeans”) of obtaining soybeans softened by steaming soybeans with vapor (or boiling soybeans in water); a step (hereinafter referred to as “the step of obtaining koji”) of obtaining grain koji by immersing grain such as rice or barley in water (or causing such grain to absorb water by sprinkling), steaming and boiling the resultant, and then inoculating and culturing Aspergillus oryzae in the steamed-boiled grain; a “mixing step” of uniformly admixing the above-softened soybeans, grain koji, and common salt; a step (hereinafter referred to as “fermentation and ripening step”) of fermenting and ripening the admixed product intact, or adding yeast or lactic acid bacteria having excellent properties to the admixed product and then fermenting and ripening the admixed product; a step (hereinafter referred to as “the pulverization step”) of pulverizing miso during fermentation and ripening or ripe miso by applying such miso to a strainer machine for miso (attritor, mesh, or granulator) to remove contaminants such as soybean husks, and kneading and crushing granular solids; and further “a sterilization step” if necessary. The thus obtained product, miso, is finally packed into a small container and sold.

In the present invention, isoflavone compounds may be added to raw materials for miso during the process for producing miso, or to miso products. It is preferable to add isoflavone compounds before, during, or after the above “pulverization step” to the raw materials for miso, because uniform addition can be easily carried out.

Isoflavone compounds may be added intact, and are preferably added after dissolution of the compounds in a solvent such as alcohol. After addition, the mixture is preferably subjected to heat sterilization by a standard method, and then commercialized.

Quantities of isoflavone compounds to be added to miso preferably range from 0.1% to 5.0% (W/W), and more preferably from 0.2% to 2.5% (W/W). When excessively low quantities of isoflavone compounds are added, much of the therapeutic or prophylactic effect cannot be expected against osteoporosis. In contrast, excessively high quantities of the same are unfavorable, because the miso flavor becomes deteriorated due to bitterness, and the production requires excessive cost.

Isoflavone compounds to be added herein may be derived from any origin. Examples of such isoflavone compounds include any isoflavone compounds such as those extracted from soy sauce cake or soy sauce oil, and those derived from soybeans or germs thereof.

Specifically, as isoflavone compounds, genistin, daidzin, and glycitin, and aglycons of these compounds including genistein daidzein, glycitein, and the like can be used. Aglycons are preferred.

A method for extracting isoflavone from soy sauce cake or soy sauce oil involves extracting soy sauce cake or soy sauce oil with an organic solvent as disclosed in, for example, JP Patent Publication (Kokai) No. 5-170756 A (1993).

In the case of soy sauce cake, a crude isoflavone compound fraction is obtained by directly condensing an extract extracted with hydrated ethanol, or allowing the extract to come into contact with an adsorbent such as an HP-20 synthetic adsorption resin (produced by MITSUBISHI CHEMICAL CORPORATION) so as to cause isoflavone compounds to be adsorbed, washing the resin with water, eluting with hydrated alcohol, condensing the eluate, and then freeze-drying or hot air drying the resultant.

The thus obtained crude isoflavone compound fraction may be used intact, or may be used after purifying the fraction to increase the purity, if necessary.

In the present invention, dried and fermented fish or a treated product thereof is added, in addition to isoflavone.

Here, a representative example of the dried and fermented fish is dried bonito. Further examples of the same include boiled-dried fish products and other forms of dried and fermented fish (dried tuna, dried mackerel, and the like). Among the forms of dried and fermented fish, dried bonito is preferred because it has the best effect of removing bitter taste.

A dried and fermented fish product is produced by boiling and ripening fish meat, and then roasting and drying the resultant, and is an ancient Japanese unperishable fishery product.

Dried and fermented fish is produced through: a boiling and ripening step of boiling and ripening fish meat (after removal of heads and organs, the fish meat has been cut fresh into 3 or 4 fillets) of bonitos, tunas, mackerels, or the like to inactivate enzymes in the fish meat and simultaneously coagulate protein, so as to facilitate the drying of the resultant; a roasting and drying step of heating and drying the resultant while fumigating the resultant by burning firewood obtained by cutting hardwood (e.g., oak) into a suitable size; a standing-to-cool step of diffusing internal moisture over the surfaces; a step of providing unique flavor by repeating the roasting and drying step and the standing-to-cool step so as to uniformly dry large pieces of fish meat; and, if necessary, a step of inoculating fungi to reduce fat contents so as to improve flavor, as well as to make the texture of the dried and fermented fish finer, and to adjust the color and sheen thereof.

Furthermore, a boiled-dried fish product is obtained by boiling and ripening small fish such as anchovies, pilchards, sand lances, horse mackerels, ligaments of scallops, shrimp, sea cucumbers, or the like in fresh water or a saline solution, and then drying the resultant in the sun or using hot air or the like until the water content of the resultant is 20% or less.

The above boiling and ripening step can inactivate bacteria attached to raw materials and enzymes within the tissue, so as to be able to suppress quality deterioration due to the action of such bacteria or enzymes. Moreover, the step also causes heat coagulation of proteins of fish meat as a raw material and alters fish meat tissue so as to cause floatation of a portion of the fish body oil, thereby facilitating dehydration and drying.

These dried and fermented fish products are preferred because the products enables to ensure a decrease in the bitter taste of isoflavone compounds with a concentration within the above range, if the products are finely pulverized (powderized) to as fine degree as possible, and specifically, to a grain size that allows grains to pass through a mesh of a mesh size ranging from 32 (sieve with 0.5 mm apertures) to 60 (sieve with 0.25 mm apertures).

Examples of a treated product of dried and fermented fish include any treated product thereof such as an alcohol extract of dried and fermented fish obtained by adding hydrated alcohol to the dried and fermented fish to perform extraction, and then condensing the obtained extract or a hot water extract of dried and fermented fish.

Examples of an alcohol extract of dried and fermented fish include those obtained by previously pulverizing dried bonito roughly to prepare chip-shaped or thin-sliced pieces of dried bonito, immersing the resultant in hydrated alcohol containing 50% to 80% (V/V) alcohol for a period of from 1 hour to overnight while heating the resultant or keeping the resultant at room temperature to remove residues, condensing the resultant, and then removing the oil layer portion. As these extracts, commercial products such as “Liquid Katsuo-Dashi (bonito stock)” or “Concentrated Katsuo-Dashi” (produced by Kikkoman Corporation) may also be used.

A method for adding dried and fermented fish or a treated product thereof to miso preferably involves uniformly adding dried and fermented fish or a treated product thereof intact, or the suspension or dissolution of dried and fermented fish or a treated product thereof in hydrated alcohol, water, or the like, to the raw materials for miso before, during, or after the pulverization step of the above miso production steps.

An amount (solid content) of dried and fermented fish or a treated product thereof to be added preferably ranges from 0.5 to 50 parts by weight per part by weight of isoflavone compounds, and more preferably ranges from 0.5 to 5 parts by weight. An excessively low amount of dried and fermented fish or a treated product thereof to be added results in insufficient decreases in bitter taste of isoflavone compounds. In contrast, an excessive amount of the same is unfavorable because it results in a heavy bonito flavor and a high cost.

### DETAILED DESCRIPTION OF THE PREFERRED EMBODIMENTS

The present invention will be further described specifically by referring to examples. However, the scope of the present invention is not limited by these examples.

### Example 1

Production Example (1) of Miso Containing Large Quantities of Isoflavone Compounds

500 ml of hydrated alcohol containing 80% (V/V) ethanol was added to 100 g of dried bonito that had been roughly pulverized. After overnight immersion at room temperature, residues were removed, and then alcohol was removed from the extract under reduced pressure. The resultant was allowed to stand, an oil layer portion was separated and removed, and then an aqueous layer portion was obtained. The aqueous layer portion was diluted with water, so that a treated product of the dried bonito (an alcohol extract of the dried bonito) with a solid content concentration of approximately 60% (W/W) was obtained.

60 g of isoflavone compounds (containing approximately 40% isoflavone aglycons) and 100 ml of the above-obtained dried bonito alcohol extract (approximately 60% (W/W) solid content) were added to and dissolved in 200 ml of pure ethanol. The resultant was admixed with 6 kg of miso before miso-koshi (before miso is strained), and then the resultant was subjected to a strainer machine for miso, thereby obtaining the miso containing large quantities of isoflavone compounds of the present invention (with a common salt concentration of approximately 11% (W/W)).

### Example 2

Production Example (2) of Miso Containing Large Quantities of Isoflavone Compounds

150 g of isoflavone compounds (containing approximately 40% (W/W) isoflavone aglycons) and 65 g of dried bonito powder that had been obtained by finely pulverizing dried bonito (approximately 8% (W/W) moisture) (the powder can pass through 35 mesh) were added to and dissolved in 200 ml of hydrated ethanol (containing 80% ethanol). The resultant was admixed with 6 kg of miso before miso-koshi, and then the mixture was subjected to a strainer machine for miso, thereby obtaining the miso containing large quantities of isoflavone compounds of the present invention (approximately 11% (W/W) common salt concentration).

### Comparative Example

Miso containing large quantities of isoflavone compounds was obtained in a manner completely the same as that in the above Example 1 except for using “100 ml of distilled water” instead of using “100 ml of dried bonito alcohol extract.”

### Control Example

Miso containing no isoflavone compounds was obtained in a manner completely the same as that in the above Example 1 except for using “60 ml of distilled water” instead of using “60 g of isoflavone compounds” and using “100 ml of distilled water” instead of using “100 ml of dried bonito alcohol extract.”

### Test Example

Preparation of Miso Soup and Sensory Test

1 liter of tap water was boiled, and then 100 g of each type of miso obtained in the above Example 1, comparative example, and control example was rapidly and uniformly dissolved therein, thereby obtaining 3 types of miso soup. A sensory test was conducted regarding bitter taste for these types of miso soup. The sensory test was conducted by trained panelists capable of recognizing taste. An evaluation method was employed wherein “−” indicates no sensation of bitter taste, “+−” indicates a subtle sensation of bitter taste, “+” indicates a sensation of bitter taste, and “++” indicates a strong sensation of bitter taste. Table 1 shows the results.

TABLE 1
Sensory test results concerning bitter taste of miso soup

| | | Presence or | |
|---|---|---|---|
| | Characteristics | absence | |
| Item | of | of bitter | |
| Classification | additive | taste | Brief comments |
| Present | Isoflavone + dried | − | Good flavor. |
| invention | bonito extract added | | Absolutely no |
| | | | sensation of bitter |
| | | | taste. |
| Comparative | Isoflavone added | + | Sensation of bitter |
| example | | | taste |
| Control | None added | − | Good flavor |
| example | | | |

As shown in the results in Table 1, panelists had a sensation of bitter taste for the miso of the comparative example to which only given quantities of isoflavone compounds had been added, but had absolutely no sensation of bitter taste for the miso of the present invention obtained by adding given quantities of isoflavone compounds and the dried and fermented fish or the treated product thereof to the miso. Thus, the miso of the present invention was shown to have good flavor.

In addition, miso soup was prepared using the miso containing large quantities of isoflavone compounds obtained in Example 2, and a sensory test was conducted for the flavor of the miso soup. Results that were almost the same as those in Table 1 were obtained. Specifically, the panelists had absolutely no sensation of bitter taste for the miso soup, so that the miso soup was shown to have good flavor.

All publications, patents, and patent applications cited herein are incorporated herein by reference in their entirety.

### Industrial Applicability

According to the present invention, miso having significantly decreased bitter taste derived from isoflavone compounds, which has been a problem in conventional miso containing large quantities of isoflavone compounds, can be obtained. The miso containing large quantities of isoflavone compounds of the present invention has no bitter taste and good flavor, and is useful for foods for use in health promotion because the miso can be expected to have a prophylactic or therapeutic effect against osteoporosis.

1. Miso with good flavor containing large quantities of isoflavone compounds, which is produced by adding 0.1-5.0% (W/W) isoflavone compounds and dried and fermented fish or a treated product thereof to miso.

2. The miso of claim 1, wherein the dried and fermented fish is finely pulverized.

3. The miso of claim 1, wherein the treated product of the dried and fermented fish is a hot water extract or an alcohol extract of the dried and fermented fish.

4. The miso of any one of claims 1 to 3, which is produced by adding 0.5 to 50 parts by weight of the dried and fermented fish or the treated product thereof per part by weight of the isoflavone compounds.

5. A method for producing miso with good flavor containing large quantities of isoflavone compounds, comprising a step of obtaining steamed-boiled soybeans, a step of obtaining koji, a mixing step, a fermentation and ripening step, a pulverization step, and a sterilization step, wherein:
before, during, or after the pulverization step, 0.1% to 5.0% (W/W) isoflavone compounds and 0.5 to 50 parts by weight of dried and fermented fish or a treated product thereof per part by weight of the isoflavone compounds are added to the raw materials for miso.
